(19) United States
(12) Patent Application Publication
(10) Pub. No.: US 2011/0197692 A1
(43) Pub. Date: Aug. 18, 2011

(54) INTERLOCKING GEARBOX

(76) Inventor: Thomas Bayer, Igersheim (DE)

(21) Appl. No.: 13/021,984

(22) Filed: Feb. 7, 2011

(30) Foreign Application Priority Data
Feb. 12, 2010 (DE) 10 2010 007 927.8
Mar. 18, 2010 (DE) 10 2010 011 951.2

(51) Int. Cl. F16H 1/04

(52) U.S. Cl. 74/412 R

(57) ABSTRACT

An interlocking gearbox, with a hollow body (1), a first drive shaft (3), which is positioned at least partially inside the hollow body (1) and is in an effective connection with the hollow body (1), and possessing a second drive shaft (4), which is positioned at least partially inside the hollow body (1) and is in an effective connection with the hollow body (1).

### BACKGROUND OF THE INVENTION

The application concerns an interlocking gearbox.

It is a state of the art procedure to use so-called interlocking gearboxes to achieve as little clearance as possible. DE 603 01 648 T2 (US 2004/0020318 A1), for example, proposes to let several drive units take effect on an output drive unit. The drive shafts of the drives can be coupled with each other and interlocked against each other to achieve minimal clearance at the output drive. However, the configuration revealed in this patent document is relatively large and cumbersome, giving problems with mounting in some circumstances.

The object of the invention is to improve the gearboxes known in state of the art technology and a specific objective of the invention is to define an interlocking gearbox with little clearance, high stiffness and a compact construction form. Ideally, a gearbox in accordance with the invention is also able to transfer high torques.

### SUMMARY OF THE INVENTION

The object is achieved by providing a gearbox which comprises a hollow body, a drive shaft partially located in the hollow body and connected thereto, and a second drive shaft partially located in the hollow body and connected thereto.

The gearbox in accordance with the invention includes a design in which each of two drive shafts are at least partially positioned inside a hollow body or a hollow shaft and each are connected with the hollow body or are in an effective connection with the hollow shaft. The hollow body is preferably circular and preferably comprises at least one inner ring gear. In typical embodiments, the hollow body is preferably formed as a hollow shaft or a hollow wheel. In the context of this patent application, the concept of a hollow shaft should be understood to mean that the hollow shaft also may be securely connected to the casing or may even form the casing itself. It should be mentioned that the concept of a hollow shaft also includes hollow wheels, which may be viewed as short hollow shafts. A hollow wheel that puts two ring gears or two drive shafts into an effective connection with each other is herein referred to as a hollow shaft. The hollow shaft is preferably securely fixed to a casing or itself forms the casing. Due to the effective connection with the hollow shaft, an interlocking of the two drive shafts is possible thus creating a drive with minimal clearance.

In a preferable arrangement there lies, positioned between at least one of the two drive shafts and the hollow shaft, a ring gear with radially moving gear teeth. This ring gear with radially moving gear teeth in this instance provides the effective connection between the hollow shaft and the respective drive shaft. For the radially moving cams, reference is preferably made to gearboxes as revealed in DE 10 2006 042 786 A1 (US 2009/0205451 A1). Hereby an explicit reference is made to design of the ring gear with radially moving gear teeth in the therein revealed embodiments. Due to the employment of radially moving gear teeth, gearboxes with extreme transmission or reduction ratios can be created. Thus, it is possible to create a very compact and highly reducing gearbox, which additionally has very little clearance due to interlocking.

Preferably, the two drive shafts are both driven by one motor each, while the two motors are connected by a control unit. The fact that the drive is powered by two motors and one gearbox in a realization embodiment has the advantage that it is possible to create a master/slave configuration. In a master/slave configuration, respectively a master/slave operating mode, one of the two motors is operated with a slight retardation relative to the other motor, so that one of the motors powers the drive, while the other motor lags behind the drive of the first motor and thus exerts braking power on the first motor. In this operating mode, an interlocking of the drive shafts is possible, so that a minimal clearance and a high stiffness of the gearbox are achieved. In advantageous embodiments of the invention, it is possible to operate the two drive shafts in this mode so as to achieve interlocking, or to operate the two drive shafts in an alternative operating mode, in which the two drive shafts are operated in the same direction with as high a drive velocity as possible, and with as high a torque as possible, with no interlocking, thereby enabling, say, a machine tool to get into working position quickly.

Further preferred embodiments of the gearbox are thus arranged as to enable the two drive shafts to be connected with one motor each, to be powered by that motor. This provides the advantage that different motors can be employed and above-said advantages of different operating modes can be achieved.

Preferably, the radially moving gear teeth of the ring gear or of the ring gears are movable by a, or at least one, guiding assembly which is connected to the drive shaft in a torque-proof manner. In a preferred embodiment of the invention, at least one ring gear for each drive shaft is included in the design, which ring gear or its gear teeth are radially movable by a guiding assembly. The guiding assembly or each of the guiding assemblies is designed to possess a varying outer radius. Preferably, the guiding assembly is designed as a guiding ring. The gear teeth of the guiding assembly and the guiding assembly are positioned or designed in such a manner that they are, in case of a turning of the guiding ring relative to the ring gear, radially moved due to the changing outer radius of the guiding ring. In this instance, the reference of the terms guiding ring and guiding device is generally meant to also include ellipsoid sub-bodies fastened on to an internally positioned ring, or other sub-bodies which form a “hump” on an internally positioned ring. Especially significant is the surface form of the ring or ring section, which has the effect that the gear teeth are moved radially outwards, all according to the angular position of the drive shaft.

In typical embodiments of the invention, the gear teeth are, for example, in each instance due to pressure by a spring, pressed against the guidance ring, so that the guidance ring in each instance presses the gear teeth outwards, if, in case of a turning of the guidance ring, the radius of the guidance ring increases at the pertaining place. In this instance, the spring causes a drawing back of the gear teeth when the radius decreases due to further turning. In further typical embodiments, the gear teeth are merely pressed outwards by the guidance ring. This has the advantage of a simple structure. A pressing back of the gear teeth is effected by the contact with the inner gearing of the hollow shaft.

Preferred guidance rings have at least two maximums of the outer radius, which maximums are preferably positioned opposite to each other or evenly distributed over the circumference. This has the effect that an especially even distribution of forces is achieved without unnecessary torque load on the drive shaft around a transverse axis. Again, additional attention is drawn to the fact that, in typical embodiments, the guidance ring may be comprised of several subsections, for example by an internally positioned ring with caps which are fastened as segments.

Preferably both drive shafts are each connected with a ring gear possessing moving gear teeth, especially by a guiding ring, in which instance both ring gears mesh with the same inner ring gear of the hollow shaft. Here it must be noted that in each instance only individual gear teeth among the moving gear teeth of the ring gears mesh. This provides the advantage that only one inner ring gear needs to be included in the design of the hollow shaft.

In preferred embodiments of the invention, the moving gear teeth are positioned inside a gear tooth cage. Especially preferred is a design by which the moving gear teeth of both ring gears are positioned in exactly one, common, gear tooth cage. This provides the advantage that only one gear tooth cage needs to be included in the design. Additionally, it is thus possible to interlock the drive shafts via the gear tooth cage, the gear teeth and the hollow shaft.

The term “moving gear teeth” is preferably also meant to include flexible ring gears, so-called flexsplines. These provide the advantage of a simple structure. Individual teeth, positioned in a gear tooth cage or on a planetary chain provide the advantage of higher stability, a greater stiffness and higher transmittable torque.

Preferably, the gear teeth are connected with a drive shaft. Connected means, in this instance, that the gear teeth are connected with the drive shaft in the direction of rotation movement, thus transmitting an output torque. This implies that moving the gear teeth in a direction of rotation movement or by a certain amount of angular degrees around the longitudinal axis of the gear box leads to a turning of the output shaft by a corresponding number of angular degrees. In typical embodiments, the gear tooth cage is connected with the output shaft in order to transmit torque.

Advantageously, the gear tooth cage, in which the gear teeth are radially positioned, is connected with the output drive shaft, thus transmitting torque. In this manner, the rotating movement of the gear tooth cage is transmitted to the output shaft. With the gear box thus created extreme transmissions can be achieved.

Advantageously, the first drive shaft is at least partially positioned inside the second drive shaft. This provides the advantage of an extremely compact construction form. Additionally, it is thus possible to organize the drive from one side of the gear box, and on the other side in the axial direction to have the output. In especially preferred embodiments, the first and the second drive shafts are made hollow, while one is partially contained in the other. Inside the inner drive shaft, cables may, in this configuration, be led.

In preferred embodiments of the invention, at least one of the motors is at least partially positioned inside the circumference of the hollow shaft. Preferably, at least one of the motors is, or all the motors are positioned coaxially to the hollow shaft. Especially preferred is a design by which the motors have a size equal to or smaller than the circumference of the hollow shaft. In other preferred embodiments the hollow shaft carries stator coils of the motors, in which instance the rotors of the motors are positioned inside the internally positioned drive shafts and at least one motor is to best advantage made as a hollow shaft motor. This gives the advantage of an especially compact make. Preferably, the hollow shaft is, in this instance, also used as the casing or at least as an inner casing.

In further typical embodiments of the invention, at least one of the motors is positioned radially outside of the hollow shaft. In a drive by spur gears of the drive shafts or of at least one of the drive shafts, a gear box or drive with a minimal axial size is created.

Preferably, the gear box or the drive contains a control unit, which is connected with both motors and designed to operate the motors without interlocking in the first operational mode, and to operate them with interlocking in a second operational mode. This provides the advantage that in the first operational mode a position can quickly be attained and in the second operational mode, as in an operational mode with interlocking, an especially exact working or positioning becomes possible, because faults due to clearance in the gear box can be avoided.

The concept motor preferably refers to an electromotor or a hydraulic motor, which provides the advantage of a high power density. Preferably, motors should read as “drives” in general, while in typical embodiments a motor is used, which via a gear box projects an effect on to two shafts and thus provides two drives. This has the advantage that only one motor is required.

### BRIEF DESCRIPTION OF THE DRAWINGS

Preferred embodiments and special implementations of the invention are explained in greater detail below, in accordance with the following figures:

FIG. 1 shows a first gear box in accordance with the invention in a schematic sectional view.

FIG. 2 shows a drive in accordance with the invention, possessing a gear box in accordance with FIG. 1 in a schematic sectional view.

FIG. 3 shows a second embodiment, in accordance with the invention, of a gear box in a schematic sectional view.

FIG. 4 shows a drive in accordance with the invention with a gear box in accordance with the invention based on FIG. 3 in a schematic sectional view.

FIG. 5 shows in perspective view schematically the drive in FIG. 4.

### DETAILED DESCRIPTION

In a description of the sectional view of FIGS. 1-4, it should be kept in mind that each of the respective sectional views only shows a part of the gear box or of the drive, while in each instance one half has, for all practical purposes, been omitted in the drawings, since they are built symmetrically or do not contain any further detail compared with the side shown in the drawing.

In FIG. 1, a gear box, in accordance with the invention, possessing a hollow shaft 1 as hollow body, an output shaft 2, a first drive shaft 3 and a second drive shaft 4 is shown. The output shaft 2 is made to be comprised of a single part with a gear tooth cage 5, in which moving teeth 6 and 7 of two ring gears are positioned.

Concerning the gear tooth cage and the ring gears, again, explicit reference is made to DE 10 2006 042 786 A1 (US 2009/0205451 A1), which is incorporated herein by reference. In this application, it is explicitly revealed how the ring gear with the moving gear teeth is positioned and preferably embodied. As differing from the said application documented it needs nothing that the gear tooth cage 5 of the preferred embodiments comprises two ring gears with moving gear teeth 6 and 7.

The moving gear teeth 6 and 7 mesh, all according to the radial position, with an inner ring gear 10 of the hollow shaft 1. Additionally, the hollow shaft 1 also possesses a fastening flange 11, with which the whole gear box can be fastened. The hollow shaft 1 is hereby in a fixed position and functions as a fixed hollow wheel of a planetary gear box.

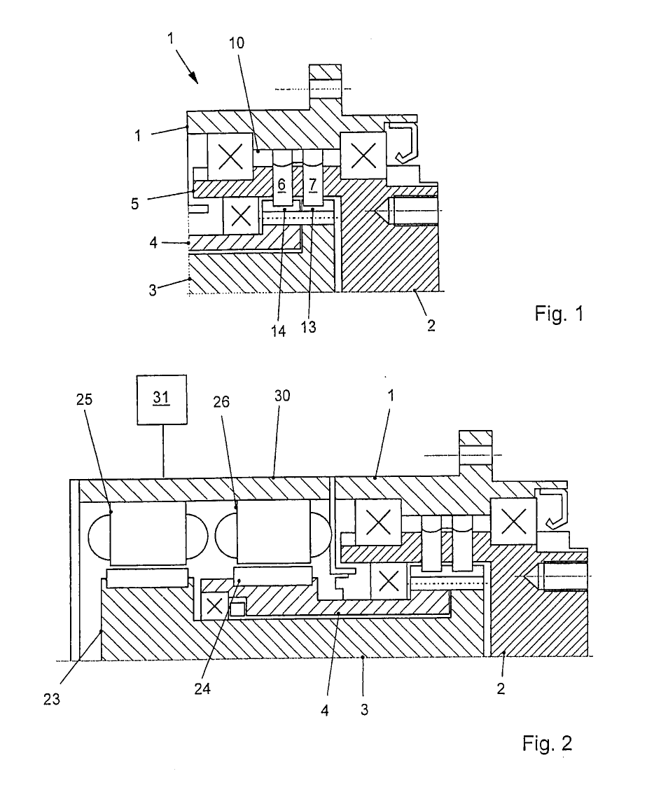

Both drive shafts 3 and 4 are each connected with the guiding assemblies 13 and 14, which cause a radial movement of the gear teeth 6 and 7, all according to the angular position of the shafts 3 and 4. For this, the guidance assemblies 13 and 14 are formed as guidance rings with a variable outer radius, as is, for example, shown in FIG. 2 of DE 10 2006 042 786 A1 (US 2009/0205451 A1). The powering of the gear teeth 6 and 7 is also to be designed accordingly. Here, the gear teeth do not need to be pressed against the outer circumference of the guidance ring 13, 14 in order to move them back inwards radially. Thus, by driving further gear teeth into the inner gearing 10 of the hollow shaft 1, a torque is brought upon the gear tooth cage 5, which makes the gear teeth exert a back-driving force on the gear teeth 6 and 7 in places where the circumference of the guidance assembly 13, 14 become smaller again due to the turning movement of the guidance assembly 13, 14, so that said gear teeth 6, 7 are radially shoved inwards with no further parts required.

Typical embodiments comprise an internally positioned ring with bulges on its surface, so that a radius varying in the direction of the circumference is created. On this rotating running surface thus formed, needles or drums preferably roll off, according to the functional mode of needle bearings or drum bearings. On the needles, a further ring is positioned—preferably made of elastic material or comprising several ring segments. The outer surface of this additional, outer ring is in contact with the gear teeth and, if required, drives these outwards. In this instance, the outer ring adapts, at least to all practical purposes, to the rotation velocity of the gear teeth, so that no or very little friction occurs between the gear teeth and the outer, additional ring. A complementary reference is made to DE 10 2007 019 607 (US 2010/0024593 A1), incorporated herein by reference, which reveals, and instructs on, possible drives of the gear teeth in radial direction.

A further alternative, which is used in typical embodiments of the invention, is a bearing of the gear teeth with pins directed in the longitudinal direction of the gear box in a guidance ring. The pins mesh in a circumferal groove of the guidance ring with a varying radius. In this manner, the gear teeth are forcibly guided. In the groove or on the guidance ring, the gear teeth can be mounted on bearings, the bearings taking in the form of drum bearings. Just as feasible is a friction bearing.

By powering the drive shaft 3 and 4 with two motors, which are connected in a master/slave configuration, it is possible to operate the gearbox with interlocking. This design achieves that the clearance of the gearbox is minimized and the stiffness is enhanced. In this instance, the interlocking is achieved via the gear tooth cage 5 and by supporting the gear teeth at the inner gearing of the hollow body 1.

In a second operating mode, the drive shafts 3 and 4 are driven without interlocking by two motors, so that the gearbox is operated without interlocking. This enables running at a high speed on the output drive shaft 2 and a high transmission of torque.

In FIG. 2, the gearbox of FIG. 1 is shown together with two drive motors. For the figure description of FIG. 2, the same reference numbers are taken for parts which are the same as or similar to those in FIG. 1, thus abstaining in part from a repeated description. Also, not all reference numbers of FIG. 1 reappear in FIG. 2.

The first drive shaft 3 at the same time forms a rotor 23 of a first electromotor. In the same manner, the second drive shaft 4 forms a rotor 24 of a second electromotor. These two electromotors are the motors that drive the gearbox. Additionally, the electromotors possess a first stator 25 and a second stator 26, the first stator 25 operating in unison with the first rotor 23 of the first drive shaft 3, while the second stator 26 operates in unison with the second rotor 24 of the second drive shaft 4.

The electromotors are positioned coaxially in relation to the gearbox. The stators 25 and 26 are positioned in such a manner that they are fixed on a casing which is positioned coaxially in relation to the hollow shaft 1. Additionally, the casing 30 is permanently connected to the casing 30. In this manner, the motors and the gearbox form a cylindrical drive.

The two motors are controlled by a control unit 31, which enables the motors to be operated in a first operational mode and in a second operational mode. In typical embodiments of the invention, the control unit 31 can precipitate and control other operational modes as well. The function of the first operational mode is to operate the gearbox in interlocking, in order to achieve great positional exactitude. The great positional exactitude is achieved by in minimization of clearance in the gearbox.

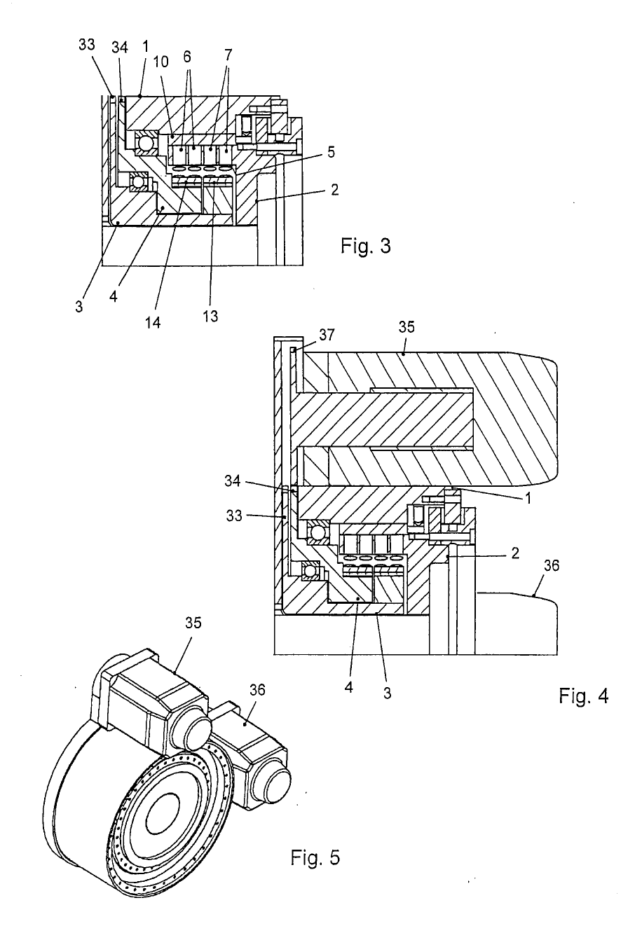

In FIG. 3, a further embodiment of a gearbox in accordance with the invention is schematically shown in a partial sectional view. For the description of FIG. 3, the same reference numbers are used for the same of similar parts as found in the gearbox in FIG. 1.

The significant difference to the gearbox in FIG. 1 is the fact that in the gearbox in FIG. 3, the drive shafts 3 and 4 are powered via the spur gears 33 and 34. The spur gear 33 is formed as an integral part of drive shaft 3, and the spur gear 34 as an integral part of drive shaft 4. This enables, in the axial direction, a very compact make of the gearbox in FIG. 3. Additionally, the gearbox is fit for higher torques, since it has two gear tooth rings each for both drive shafts 3,4, with gear teeth 6 positioned axially side by side of each other, to ensure the transmission of the torque of the drive shaft 4. The torque of drive shaft 4 is transmitted by gear teeth 7 positioned axially side by side each other.

In FIG. 4, the gearbox of FIG. 3 shown once more, again using the same reference numbers for parts which are the same or similar, while in FIG. 4 a complete drive is schematically shown in a partial sectional view, where the gearbox in FIG. 3 is employed.

The drive in FIG. 4 includes two electromotors 35 and 36. Electromotor 35 powers the spur gear 34 with a pinion 37. The electromotors 35 and 36 in FIG. 4 are only indicated schematically. However, they are similar to the electromotors in FIG. 2, of a make which includes stators and rotors. Electromotor 36 powers spur gear 33, which is connected to the first drive shaft. As in the embodiment in FIG. 2, a control unit with the above described functions is again included in the design.

In FIG. 5, the drive in FIG. 4 is shown once more, this time in a perspective view. It is clearly indicated that the drive in FIG. 5 is very compact in axial direction. The fact that it is possible to employ the drive in FIGS. 4 and 5 via the control unit not shown in FIGS. 4 and 5 in at least two operational modes (refer to the above in connection with FIGS. 1 and 2), allows the drive to enable a whole variety of usages.

1. An interlocking gearbox comprising:
a hollow body (1) having an internal teeth ring (10);
a first drive shaft (3) positioned at least partially inside the hollow body (1) and in an effective connection with the hollow body; and
a second drive shaft (4), which is positioned at least partially inside the hollow body (1) and in an effective connection with the hollow body (1).

2. Gearbox according to claim 1, wherein between at least one of the two drive shafts (3, 4) and the hollow body (1) with internal teeth ring (10) is located, a ring gear possessing radially moving gear teeth (6, 7).

3. Gearbox according to claim 2, wherein the radially moving gear teeth (6, 7) of the ring gear are movable by a guidance assembly (13, 14), which is securely connected to one of the drive shafts (3, 4).

4. Gearbox according to claim 1, wherein both drive shafts (3, 4) are each connected with a ring gear possessing movable gear teeth, in which instance both ring gears are meshed with the same internal teeth ring (10) of the hollow body (1).

5. Gearbox according to claim 2, wherein the gear teeth (6, 7) are positioned to be radially moving in a gear tooth cage (5).

6. Gearbox according to claim 5, wherein at least one of the gear teeth (6, 7) and the gear tooth cage (5) are connected with an output drive shaft (2) for torque transmission.

7. Gearbox according to claim 1, wherein the first drive shaft (3) is positioned at least partially inside the second drive shaft (4).

8. Gearbox according to claim 1, wherein the two drive shafts (3, 4) are each driven by a separated motor.

9. Gearbox according to claim 8, wherein at least one of the motors is positioned at least partially inside a circumference of the hollow body (1).

10. Gearbox according to claim 8, wherein at least one of the motors is positioned radially outside of the hollow body (1).

11. Gearbox according to claim 8, wherein a control unit (31) is connected and configured with both motors and operates the motors without interlocking in a first operational mode and interlocked in a second operational mode.

12. Process for operating the drive according to claim 11, comprising the following steps:
issuing command to and exerting control over both motors, so that they power the two drive shafts (3, 4) without interlocking in a first operational mode and
issuing command to and exerting control over both motors so that they power both drive shafts (3, 4) in an interlocked manner in a second operational mode.
